(19) United States
(12) Patent Application Publication
(10) Pub. No.: US 2019/0160491 A1
(43) Pub. Date: May 30, 2019

(54) MULTI-ELEMENT, CAPACITIVE, ULTRASONIC, AIR-COUPLED TRANSDUCER

(71) Applicants: UNIVERSITE DE BORDEAUX, Bordeaux (FR); INSTITUT POLYTECHNIQUE DE BORDEAUX, Talence Cedex (FR); CENTRE NATIONAL DE LA RECHERCHE SCIENTIFIQUE, Paris Cedex 16 (FR); ECOLE NATIONALE SUPERIEURE DES ARTS ET METIERS, Paris (FR)

(72) Inventors: Christine BIATEAU, Talence (FR); Michel CASTAINGS, Pessac (FR); Mathieu RENIER, Bordeaux (FR)

(21) Appl. No.: 16/320,856

(22) PCT Filed: Jul. 24, 2017
(86) PCT No.: PCT/EP2017/068663

§ 371 Date: Jan. 25, 2019

(30) Foreign Application Priority Data
Jul. 28, 2016 (FR) 1657305

(51) Int. Cl. B06B 1/02; G01N 29/24

(52) U.S. Cl. CPC B06B 1/0292; G01N 29/2406

(57) ABSTRACT

A multi-element, capacitive, ultrasonic, air-coupled transducer includes a membrane having an electrically conductive face; and a plurality of electrically separate conductive elements, consisting of a central disc and a plurality of rings arranged concentrically with the central disc, the conductive elements each having a face arranged facing the membrane and the faces of the conductive elements being of the same surface area; wherein the central disc has a radius of between 10 mm and 15 mm and wherein the number of conductive elements is between 12 and 18.

### TECHNICAL FIELD

The present invention generally relates to the field of ultrasound non-destructive testing. The invention more particularly relates to an air-coupled capacitive type ultrasonic transducer enabling ultrasound to be generated and/or detected.

### STATE OF THE ART

Ultrasound non-destructive testing enables a structure, for example made from composite material or from metal, to be rapidly inspected, without being deteriorated and sometimes without being disassembled. By propagating in the material of the structure, ultrasound waves provide information about the mechanical properties of the structure and reveal the presence of defects, at the surface or in depth. By way of example, ultrasound waves can indicate the presence of cracks, delaminations and porosity zones in the structure, because these defects modify the wave amplitude and/or form.

Ultrasound non-destructive testing methods most often use a liquid coupling medium, being a proper ultrasound wave conductor, as water or a gel. This liquid coupling medium enables acoustic impedance matching to be made between the ultrasound wave transmitting and receiving probes, also called transducers, and the structure to be inspected. The presence of the liquid coupling medium between the transducers and the structure can be ensured by partially or totally dipping the structure into the liquid or by a liquid continuous supply, for example as water jets. These non-destructive liquid-coupled testing methods are however heavy to implement, because of the necessity to provide a tank or a liquid supply device. They also require to wash and/or dry, and sometimes disassemble, the parts. Moreover, they are not adapted to the testing of some types of structures not tolerating coupling with a liquid. So-called “sandwich” structures integrating one or more alveolar layers (foam, honeycomb, etc.), widespread in the aeronautics industry, can be mentioned by way of example.

By comparison, contactless ultrasound non-destructive testing methods, where ambient air is used as a coupling medium, are simpler to implement and make a continuous inspection of the structures possible. However, they require to provide air-coupled transducers the efficiency of which is high, in order to compensate for the very strong attenuation of the ultrasound waves undergone at each interface between air and the solid materials (air/transducer interface(s) and air/structure interface(s)).

Capacitive ultrasound transducers today allow the transmission of ultrasound waves in air at high levels and the reception thereof with a sufficient sensitivity to use air as a coupling medium. These transducers further have a better frequency bandwidth than the piezoelectric type transducers. They can consist of a single capacitive element or a multitude of capacitive elements, independent from the electric point of view. In comparison with the single element technology, the multi-element technology enables the transducer spatial resolution to be increased. Indeed, by electronically driving each of the elements, different settings such as angular scanning and focusing can be achieved. The multi-element transducers can assume different geometries, in particular linear, annular, matrix form and circular geometries.

The Capacitive Micromachining Ultrasonic Transducer (or CMUT) is an example of a multi-element transducer. It consists of a large number of micro-diaphragms organised in a network and electrostatically actuated. This transducer is particularly compact, because it is manufactured from a silicon substrate using surface micromachining techniques. However, because of the geometry of the element network, in the form of a linear bar or a matrix, the transducer CMUT is not the most adapted to achieve an ultrasound wave focusing. An ultrasound wave focusing is possible, by arranging the elements on a curved substrate the curvature of which sets the central value of the focus. The focusing distance thereby cannot vary (or otherwise very slightly), because of the low number of elements arranged on the support. The elements of the transducer CMUT are manufactured in small numbers, because the piezoelectric materials constituting them are difficult to machine on a small scale. This incapability to modify the focusing distance involves to provide as many transducers CMUTs as there are possible applications.

Document [“Numerical modelling for the optimisation of multi-element, capacitive, ultrasonic, air coupled transducer”, D. Zhang et al., Journal of Physics: Conference Series, Volume 457, 012011, 2013] describes another example of multi-element capacitive ultrasonic air-coupled transducer, with an annular configuration.

This capacitive transducer comprises a membrane, a face of which is metallised, and a metal rear plate on which the membrane is attached. The rear plate includes eight elements with an identical active surface, distributed into a central disc and seven concentric rings. This transducer has a wide frequency bandwidth, a high efficiency and enables the ultrasound wave beam to be focused, in order to adjust the spatial resolution. Further, it enables the focusing distance to be dynamically adjusted, by applying variable delays to the excitation electrical signals sent to the elements (“transmitter” mode) or delivered by the elements (“receiver” mode).

The multi-element capacitive transducer of the abovementioned document however does not simultaneously offer a large flexibility for setting the focusing distance, a high-pressure level and a satisfactory resolution for targeted applications.

### SUMMARY OF THE INVENTION

Thus, there is a need for providing a multi-element capacitive ultrasonic air-coupled transducer provided with a large flexibility in setting the focusing distance, while having optimum spatial resolution and pressure level, in order to widen the application field of this transducer type.

According to the invention, this need tends to be satisfied by providing a multi-element capacitive ultrasonic air-coupled transducer comprising:
a membrane having an electrically conductive face; and
a plurality of electrically independent conductive elements, consisting of a central disc and several rings arranged concentrically with the central disc, the conductive elements each having a face arranged facing the membrane and said faces of the conductive elements being of the same surface area;

wherein the central disc has a radius between 10 mm and 15 mm and wherein the number of the conductive elements is between 12 and 18.

With such an active surface (the selected radius sets the active surface of the central disc and consequently that of all the conductive elements) and such a number of conductive elements, the capacitive transducer according to the invention benefits from a wider focusing range. Further, by virtue of the selected number of elements, the transducer according to the invention has better pressure efficiency and spatial resolution than those of the transducer of prior art. Such a number of elements finally offers the possibility of more finely setting the focusing distance, that is with a smaller pitch.

The possibilities of setting the frequency and the focusing distance are consequently increased, which enables a greater number of applications to be satisfied. For example, in the case of the non-destructive testing of structures, the transducer according to the invention enables thinner defects located at a greater depth in the structures to be detected. Without moving the transducer, just by modifying the focusing distance, it is possible to be adapted to structures the surface geometry of which would be variable, for example a composite plate with a step or a thickness variation. The transducer can also enable focusing characteristics, in particular the size of the focal spot, to be adjusted, so as to detect defects the dimensions of which are beyond some critical size, without being sensitive to material homogeneities with lower sizes and that shouldn't be considered as defects. The transducer according to the invention is thus adapted to a larger variety of structures and needs, with regard to their form or composition.

Setting the focusing distance of a multi-element transducer operating in a “transmission” mode can be made by applying phase shifts to the excitation signals sent to the different elements, for example by means of a multi-channel electronics. Setting the focusing distance of a multi-element transducer operating in the “reception” mode can be made by applying phase shifts to the signals delivered by the different elements having detected an acoustic wave, still by means of a multi-channel electronics.

The conductive elements are advantageously separated by a distance between 1 mm and 1.8 mm, and preferably between 1.4 mm and 1.6 mm. According to an exemplary embodiment of the transducer according to the invention, the conductive elements are 16 in number, the central disc has a radius equal to 10 mm and the conductive elements are spaced by a distance equal to 1.4 mm.

The invention also relates to a method enabling a multi-element capacitive ultrasonic air-coupled transducer to be simply manufactured at a lesser cost, which is provided with a high performance.

This method comprises the following steps of:
forming a rear plate comprising a plurality of electrically independent conductive elements, including a central disc and several rings concentrically arranged with the central disc, the rear plate having a rear face and a front face, called an active face, opposite to the rear face; and
arranging on the active face of the rear plate a membrane having an electrically conductive face;

forming the rear plate comprising the following operations of:
machining in a metal plate a plurality of concentric annular grooves;
filling the grooves with an electrically insulating adhesive; and
removing a portion of the metal plate so as to make the adhesive-filled grooves through grooves.

The method according to the invention can also have one or more of the following characteristics taken alone or according to any technically possible combinations:
a step of micro-sandblasting the active face of the rear plate, so as to form microcavities;
a step of applying a bias voltage, preferably between 30V and 100V, between the electrically conductive face of the membrane and the conductive elements of the rear plate;
a step of attaching the rear plate inside a support by means of the electrically insulating adhesive, a portion of the support being advantageously removed at the same time as the portion of the metal plate so as to form a planar surface, the membrane being arranged on this planar surface;
the annular grooves have a same width; and
the electrically insulating adhesive is an epoxy resin.

### BRIEF DESCRIPTION OF THE FIGURES

Further characteristics and advantages of the invention will become clearer from the description thereof given below, by way of indicating and in no way limiting purposes, in reference to the appended figures, in which:

FIG. 1 schematically represents a multi-element capacitive ultrasonic air-coupled transducer according to a preferential embodiment of the invention;

FIG. 2 represents a top view of a rear plate of the ultrasonic transducer of FIG. 1;

FIG. 3 represents the maximum acoustic pressure at the Fresnel distance radiated by the transducer according to the invention, as a function of the number of elements of the rear plate;

FIG. 4 represents the lateral resolution for a focusing distance equal to the Fresnel distance of the transducer of FIG. 1, as a function of the number of elements of the rear plate;

FIG. 5 represents the variations in the amplitude of the axial pressure field radiated by the transducer according to the invention and by the transducer of prior art, at the focusing distance equal to the Fresnel distance of each of the transducers;

FIG. 6 represents variations in the amplitude of the transverse pressure field at the Fresnel distance radiated by the transducer according to the invention and by the transducer of prior art;

FIGS. 7A-7E represent steps of a method for manufacturing the rear plate according to FIG. 2 and its support of insulating material; and

FIG. 8 represents a particular way of assembling the multi-element capacitive air-coupled transducer according to the invention.

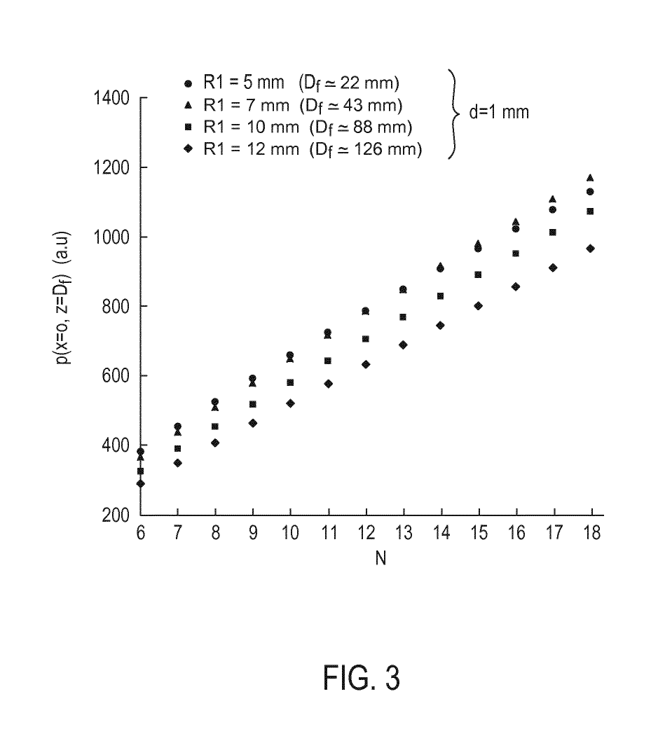

For the sake of clarity, identical or similar elements are marked with identical reference signs throughout the figures. On the other hand, in FIGS. 3, 5 and 6, the acoustic pressure is expressed in an arbitrary unit (“a.u.”).

### DETAILED DESCRIPTION OF AT LEAST ONE EMBODIMENT

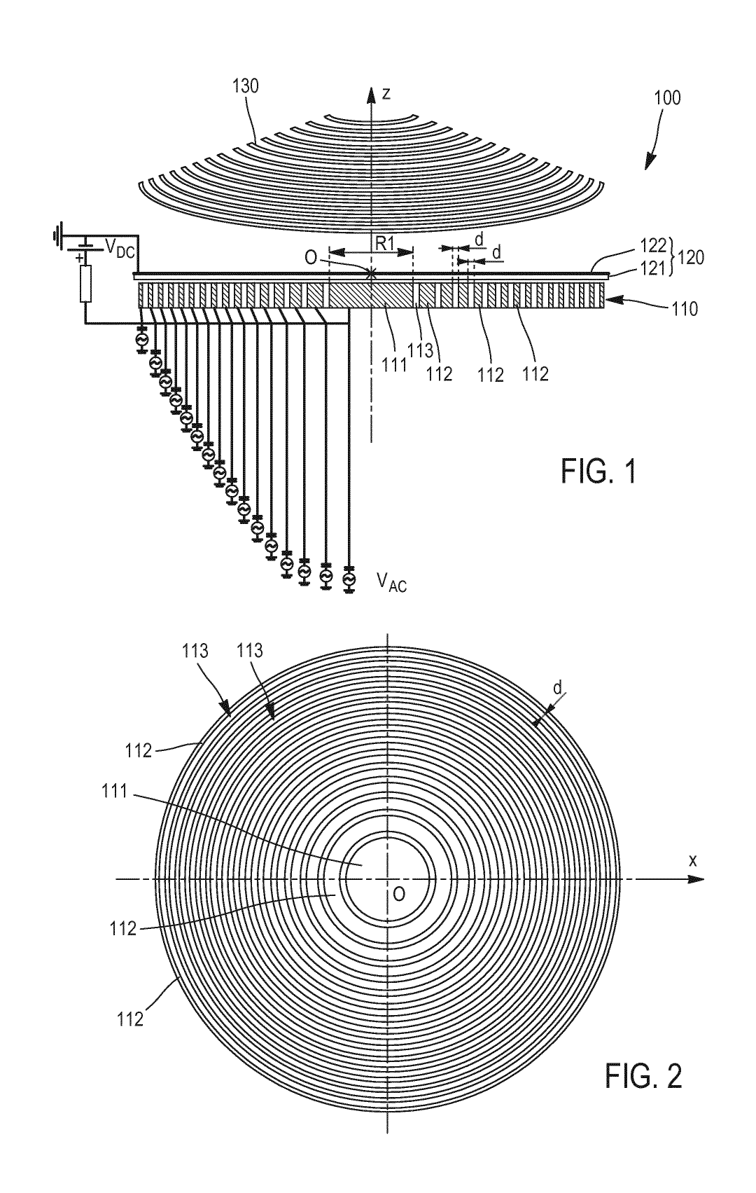

FIG. 1 represents a preferential embodiment of a multi-element ultrasonic transducer 100 of the capacitive type.

The multi-element ultrasonic transducer 100 is optimised, in terms of working frequency and spatial resolution, for non-destructively testing of materials. The purpose of this testing may be to reveal the presence of defects, such as cracks, voids or porosity, in mechanical parts or structures, to measure the thickness of the materials and/or analyse properties thereof.

The transducer 100 is air-coupled, that is it uses ambient air as a coupling medium for the ultrasound waves. Therefore, there is no contact between this transducer and the material to be tested. The advantages of this transducer type are an easy implementation of the testing procedures and the absence of contamination or pollution of the material.

The transducer 100 comprises a rear plate 110 and a membrane 120 arranged facing the rear plate 110. The rear plate 110 is rigid and bulky in comparison with the membrane 120, which is (by definition) flexible and thin. Preferably, the thickness of the rear plate 110 is between 4 mm and 10 mm, whereas the thickness of the membrane 120 is between 3 μm and 8 μm. The rear plate 110 and the membrane 120 both have the shape of a disc. At least one face of the membrane 120 is electrically conductive.

In the preferential embodiment of FIG. 1, the membrane 120 is formed by a layer of polymeric material 121, such as polyethylene terephthalate (PET), covered with a thin metal layer 122, for example of aluminium. The metal layer 122 advantageously covers the front face of the polymer layer 121, that is the face pointed towards the material to be tested (the rear face of the polymer layer 121 being directed towards the rear plate 110). The membrane 120 can thus be arranged in contact with the rear plate 110 and attached to the edges thereof, without creating a short-circuit between the metal layer 122 and the rear plate 110.

The rear plate 110, represented in a top view in FIG. 2, comprises several conductive elements spaced apart from each other, and more particularly a central disc 111 and rings 112. The rings 112 are concentrically arranged with the central disc 111. These elements (disc and rings) are preferably of metal, for example of aluminium. The disc 111 and the rings 112 are advantageously of the same thickness and interlaced with each other, such that the rear plate 110 has planar and parallel main (that is front and rear) faces (see FIG. 1). The elements 111-112 of the rear plate 110 are separated by a dielectric material 113, preferably an epoxy resin. In FIG. 2, “x” designates the radial position of the rings 112 with respect to the centre “O” of the central disc 111.

Each element 111-112 of the rear plate 110 interacts with the membrane 120 in the manner of a capacitor, to convert an ultrasound wave into an electric signal (in the manner of a microphone), and reversely (in the manner of a loud-speaker). The membrane 120 constitutes the first, movable, armature (or electrode), of the capacitor, whereas the relevant element of the rear plate 110 constitutes the second armature of the capacitor, which is rather fixed. In other words, each of the elements, the disc 111 and the rings 112, constitutes with a portion of the membrane 120, a capacitive type active element. The multi-element ultrasonic transducer 100 can thus be seen as a multitude of single element capacitive transducers, integrated in a same case and sharing the same membrane.

To generate ultrasounds, the membrane 120 of the transducer 100 is permanently pre-stressed by a D-C bias voltage V_{AC} and vibrates at a resonance frequency under the effect of an A-C excitation voltage VAC applied to each conductive element 111-112 of the rear plate 110. This movement of the membrane 120 gives rise to an ultrasound wave beam 130, corresponding to the superposition of the acoustic beams generated by the different single element capacitive transducers. In FIG. 1, the revolution axis Oz of the central disc 111 and of the rings 112 coincides with the propagation direction of the ultrasound wave beam 130. This axis Oz is hereinafter called “acoustic axis” of the ultrasound transducer 100.

The multi-element ultrasound transducer 100 has intrinsically a wide frequency bandwidth because it is of the capacitive type. This wide bandwidth makes the transducer 100 compatible with many materials, because the frequency of the A-C excitation signal VAC, called the working frequency, is chosen as a function of the material to be tested.

The active surface area S of the elements 111-112, that is the surface pointed towards the membrane 120, advantageously comprises microcavities dimensioned to increase the bandwidth and the efficiency of the transducer. This surface roughness is for example achieved by micro-sandblasting of the front face of the elements.

The acoustic pressure field of the ultrasound beam generated by a single element planar transducer emitting a purely sinusoidal wave conventionally comprises two zones: the near field zone (or Fresnel zone) where the pressure field is inhomogeneous, and the far field zone (or Fraunhofer zone) where the pressure field diverges. The Fresnel distance D_{f} is the distance at which the near field zone joins the far field zone. This distance D_{f} is that at which the ultrasound beam has the most interesting characteristics: a high acoustic pressure (when the attenuation is negligible, this is the position of the last pressure maximum) and reduced lateral dimensions (in other words a good lateral resolution). The distance D_{f} is proportional to the ratio of the active surface area S to the emitted wavelength λ, that is in the case of a source in the form of a disc with a radius r:

D_{f}=S/πλ=r²/λ (1)

For an annular source, the radius of the active surface area S to be taken into account is:

rₐ=\sqrt{rₑₓₜ²−rᵢₙₜ²}

with rₑₓₜ and rᵢₙₜ the outer and inner radiuses of the ring respectively.

The central disc 111 and the concentric rings 112 of the rear plate 110 are herein dimensioned such that they have the same active surface area S. In other words, the front faces of the central disc 111 and of the rings 112 are of the same surface area. Thus, if each of these elements 111-112 is excited by the same purely sinusoidal signal, the field radiated by each of the elements will have the same Fresnel distance D_{f}. Consequently, the pressure amplitude at this distance D_{f} will be equal to the sum of the fields radiated by the different elements.

To have an identical active surface area, the central disc 111 and the concentric rings 112 have necessarily different widths. This configuration has the advantage of minimising the amplitude of the secondary lobes of the acoustic pressure field. These secondary lobes represent part of the acoustic energy which is radiated in directions different from the acoustic axis Oz of the transducer 100 (i.e. the axis of the disc 111 and of the rings 112; see FIG. 1). They can induce artefacts on images of the inspected materials and result in detecting “wrong defects”. The unevenness in the width of the elements of the transducer is thus an advantage for achieving a beam with few secondary lobes, or even without secondary lobes.

In practice, the elements of the transducer are not excited by purely sinusoidal signals, but by wave trains. Consequently, when the excitation signals are all in phase, focusing the transducer at the Fresnel distance (common to all the rings) does not naturally occur. The ultrasound beam nonetheless has some directivity, but it is comparable with that of a single element transducer formed by a single disc having a radius equal to the outer radius of the peripheral element. The lateral resolution of such a system is not sufficient.

In order to be effectively able to improve the lateral resolution and increase the pressure maximum amplitude at the Fresnel distance, phase offsets are introduced between the excitation signals of the disc 111 and of the rings 112. That results in concentrating, or focusing, the ultrasound wave beam 130 emitted by the transducer 100 about a point located on the acoustic axis Oz of the transducer 100. The ultrasound beam 130 thereby converges to a focal zone where it becomes locally planar. At a greater distance, the beam diverges. The focusing distance, noted hereinafter Z_{f}, is measured from the source (i.e. the membrane 120) along the axis Oz and can be equal to the Fresnel distance D_{f}.

This focusing enables thinner defects to be detected with a better signal to noise ratio. The other interest of the multi-element transducer according to the invention is that the focusing distance Z_{f} and thus the detection depth can thereby be readily modified. The focusing distance Z_{f} is adjusted by modifying the relative phase shifts between the excitation signals, for example using a multi-channel electronics. The pressure amplitude and the lateral dimensions of the ultrasound beam at the focusing zone depend on the focusing distance Z_{f} and the wavelength λ.

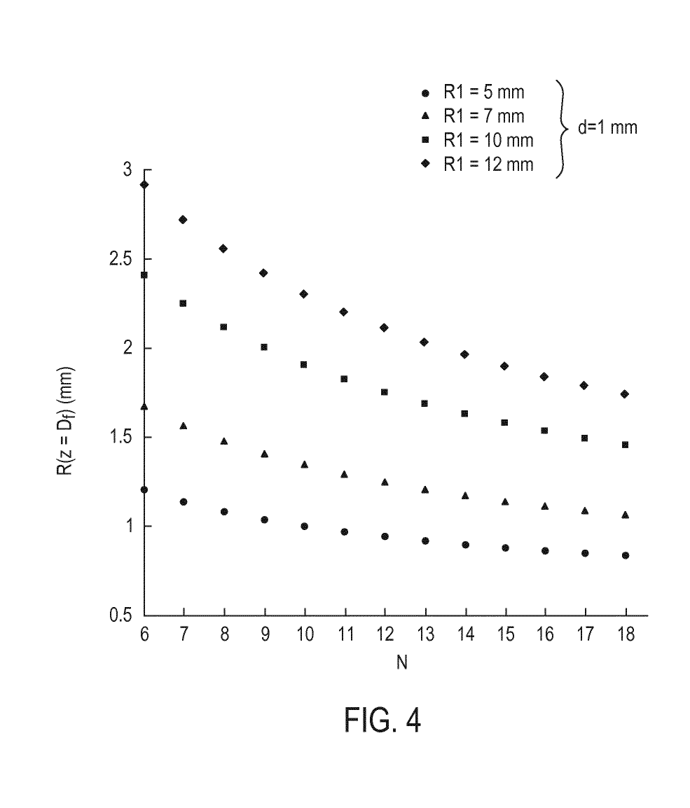

The performance of the multi-element capacity transducer 100, in terms of spatial resolution and efficiency in particular, also depends on its geometry. Digital simulations have enabled geometrical characteristics of the transducer 100 to be identified, such as the number N of elements (central disc and concentric rings) of the rear plate 110 and active surface area S of these elements, which have a strong impact on the transducer performance. The results of these digital simulations (at a frequency of 300 kHz) are given below in connection with FIGS. 3 and 4.

By definition, the transducer efficiency is defined as the ratio of the acoustic power delivered to the electric power consumed. The acoustic power is substantially proportional to the square of the acoustic pressure generated by the ultrasound wave beam. Consequently, the higher the acoustic pressure of the beam, the higher the transducer efficiency.

FIG. 3 represents the amplitude p(z=D_{f}) of the pressure maximum located at the Fresnel distance D_{f} when this distance is chosen as the focusing distance Z_{f} on the axis Oz (that is in the plane of FIG. 2, at x=0), as a function of the number N of elements of the transducer 100 and for values of the radius R1 of the central element 111 between 5 mm and 12 mm. As a reminder, the radius R1 sets the active surface area S of all the elements 111-112 (S=π.R1²). The distance d between two consecutive elements 111-112 is constant and herein set to 1 mm.

This figure shows that the amplitude p(z=D_{f}) of the pressure maximum increases with the number N of elements of the rear plate 110, for a fixed surface area S (i.e. a fixed radius R1). It also shows that the maximum pressure p(z=D_{f}) (reached at the Fresnel distance D_{f}) does not necessarily increase with the active surface area S of the elements. For example, for a number N of elements equal to 8, the maximum pressure developed by elements with a surface area S=π.R12² mm² is less (nearly by half) than the maximum pressure obtained with elements with a surface area S=π.5² mm².

FIG. 4 represents the lateral resolution R(z=D_{f}) (i.e. the dimension of the beam along the axis Ox) of the Fresnel distance D_{f}, as a function of the elements number N and for values for the radius R1 between 5 mm and 12 mm. The lower the value indicated in ordinate, the better the lateral resolution.

It is noticed thanks to this figure that the lateral resolution is improved by increasing the number N of elements (at a fixed surface area S) and by decreasing the active surface area S of the elements (for a fixed number N of elements). The dimensions of the focal spot are proportional to the focusing distance and reversely proportional to the total radius of the multi-element transducer (and thus to the number of elements). However, since the Fresnel distance is proportional to the active surface area (square of the radius of the central element), an increase in the active surface area S of the elements deteriorates the spatial resolution.

Thus, to obtain the best performance in terms of efficiency (FIG. 3) and spatial resolution (FIG. 4), the transducer 100 should have a high number of elements with a small surface area S. The efficiency and spatial resolution however are not the single criteria to be taken into consideration for dimensioning the transducer 100.

The inventors have surprisingly noticed that by choosing a number N of elements between 12 and 18 and a radius R1 of the central disc 111 between 10 mm and 15 mm, the focusing range of the multi-element transducer 100 is significantly extended. Further, its efficiency is close to the maximum level, its spatial resolution is very good and the dimensions and spacing of its various elements make its achievement possible with common machining and assembling means. Moreover, the technology based on the “capacitive” effect of the transducer provides it with a wide bandwidth, which extends from 100 kHz to 500 kHz at −20 dB. This wide bandwidth enables the operating frequency to be chosen so as to tune it to one of the resonant frequencies of the structure to be tested. Since the characteristics of the focal spot (pressure amplitude and dimensions) depend on the frequency, the focusing distance can be adjusted so as to optimise the beam to be emitted.

Once the testing frequency is chosen, this focusing distance Z_{f} can be adjusted from Z_{f-min}=40 mm to a distance Z_{f-max} equal to about twice the Fresnel distance (up to 350 mm at 300 kHz for 16 elements and R1=15 mm). By way of comparison, the bandwidth of the multi-element transducer of prior art (8 elements with a surface area S=π.7.87² mm²) is 100 kHz-500 kHz and its focusing range is about 30 mm to 110 mm.

On the other hand, with a number N of elements between 12 and 18, the transducer 100 enables the focusing distance to be more finely set, in comparison with the transducer of prior art equipped with only 8 elements. Indeed, the higher this number N, the more the delay time law applied to the excitation signals can be precisely defined.

Finally, the geometric characteristics of the transducer 100 offer good compromises between performance and difficulties for manufacturing the rear plate. Indeed, a rear plate with a very high number of rings (>20) with a small surface area (R1<10 mm) can be in particular difficult to machine, in particular if it consists of a metal like aluminium.

The distance d between two consecutive elements 111-112 is advantageously between 1 mm and 1.8 mm, and preferably between 1.4 mm and 1.6 mm. By virtue of this small spacing between the elements 111-112, the multi-element ultrasound transducer 100 remains compact and can thus be more readily used.

According to a particular example of embodiment, the multi-element ultrasound transducer 100 includes a central disc with a radius R1 equal to 10 mm and 15 concentric rings with the same active surface area, that is in total 16 conductive elements. The distance between two consecutive elements is constant and equal to 1.4 mm.

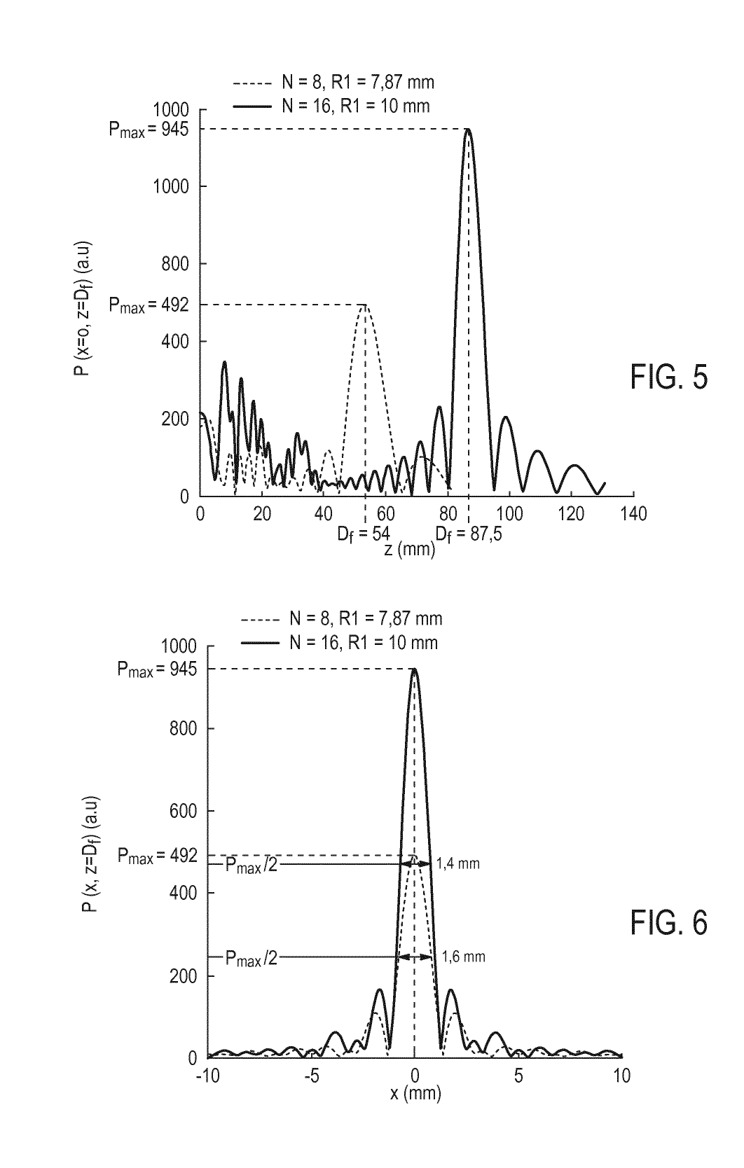

FIG. 5 represents a calculation of the amplitude of the axial acoustic pressure p(z) (i.e. along axis Oz) radiated by this exemplary transducer according to the invention (solid line curve) and, by way of comparison, that developed by the transducer of prior art (dotted line curve). In this figure, each of the transducers focuses at its own Fresnel distance. In the same way, FIG. 6 represents the transverse acoustic pressure p(x) at the focusing distance (i.e. Z_{f}=D_{f}) for both these transducers. The frequency is the same in both cases (300 kHz).

FIG. 5 shows that the axial resolution (in the direction of the acoustic axis Oz) is also improved, since the main lobe of the axial acoustic pressure p(z) is narrower for the 16-element transducer than for the 8-element transducer. The improvement is here about 25% (9 mm instead of 12 mm).

FIG. 6 shows that the lateral resolution of the ultrasound beam calculated for the 16-element transducer is thinner by about 12% than that of the 8-element transducer (1.4 mm versus 1.6 mm). This lateral resolution is measured, for each curve, by reading out the full width at half maximum (Pₘₐₓ/2) of the main lobe of the transverse acoustic pressure p(x).

It is further noticed in these figures that the amplitude Pₘₐₓ of the acoustic pressure maximum (at the Fresnel distance D_{f}) of the 16-element transducer is approximately twice higher than that of the 8-element transducer (945 versus 492 in arbitrary units). The efficiency of the 16-element transducer is consequently sharply higher (by a factor 4) than that of the 8-element transducer.

After digital calculations made for different focusing distances (still at a frequency of 300 kHz), the table below gives the orders of magnitudes of the performance for the transducer of prior art and two exemplary transducers according to the invention.

| | Focusing | Pressure | Lateral | Axial |
|---|---|---|---|---|
| | distance Z_{f} | pₘₐₓ | resolution | resolution |
| | (mm) | (a.u.) | (mm) | (mm) |
| N = 8 | 30 | ≈250 | 1.1 | 6 |
| R1 = 7.87 mm | 54 | ≈490 | 1.6 | 12 |
| | 110 | ≈330 | 3.0 | 42 |
| | 180 | ≈160 | 4.9 | 99 |
| N = 16 | 40 | ≈500 | 0.8 | 5 |
| R1 = 10 mm | 87.5 | ≈950 | 1.4 | 9 |
| d = 1.4 mm | 180 | ≈500 | 2.8 | 31 |
| N = 16 | 40 | ≈590 | 0.7 | 6 |
| R1 = 15 mm | 160 | ≈750 | 1.8 | 15 |
| d = 1.4 mm | 350 | ≈350 | 3.8 | 62 |

The data values given in italics for the transducer of prior art at a focusing distance of 180 mm, outside the focusing range signalled, are given only by way of comparative purposes (the pressure is much lower therein with respect to a 16-element transducer).

The multi-element ultrasonic transducer according to the invention thus has a higher performance in terms of spatial resolution and efficiency with respect to the capacitive multi-element transducer of prior art. The high efficiency and resolution promote detection and location of small-size (in the order of one millimetre) defects, whereas the wide frequency bandwidth allows a great number of applications. More particularly, the transducer 100 enables parts or structures with a complex shape, consisting of various materials (metals, polymeric or composite materials, wood, ceramics . . . ) to be tested. Finally, unlike other capacitive type transducers, the transducer 100 has the ability to be able to dynamically modified the focusing distance. Indeed, it is possible to create a focal spot with an amplitude higher than half the maximum amplitude over distances between 40 mm and about twice the Fresnel distance of the transducer. Therefore, it can be substituted for a plurality of transducers each having a fixed focusing distance.

Besides the non-destructive testing, which mainly relates to industrial applications (spatial, aeronautics, civil engineering . . . ), the multi-element ultrasonic transducer according to the invention can be suitable for applications in the telemetry field.

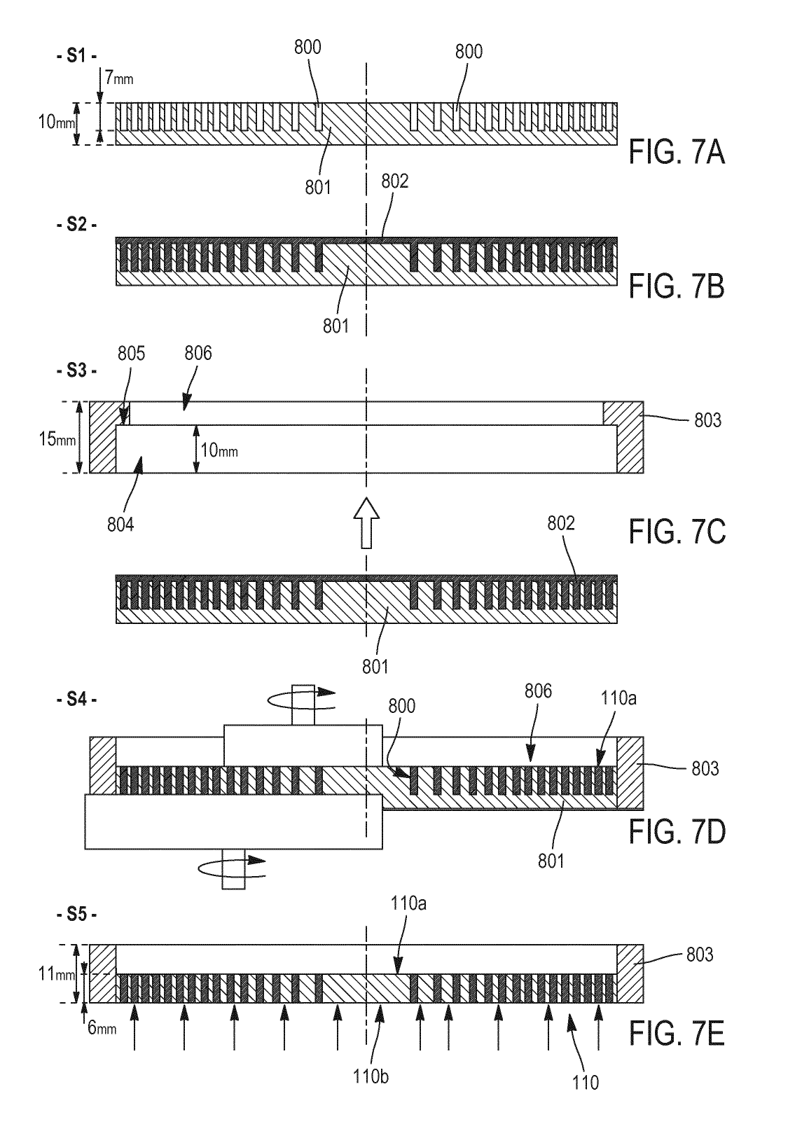

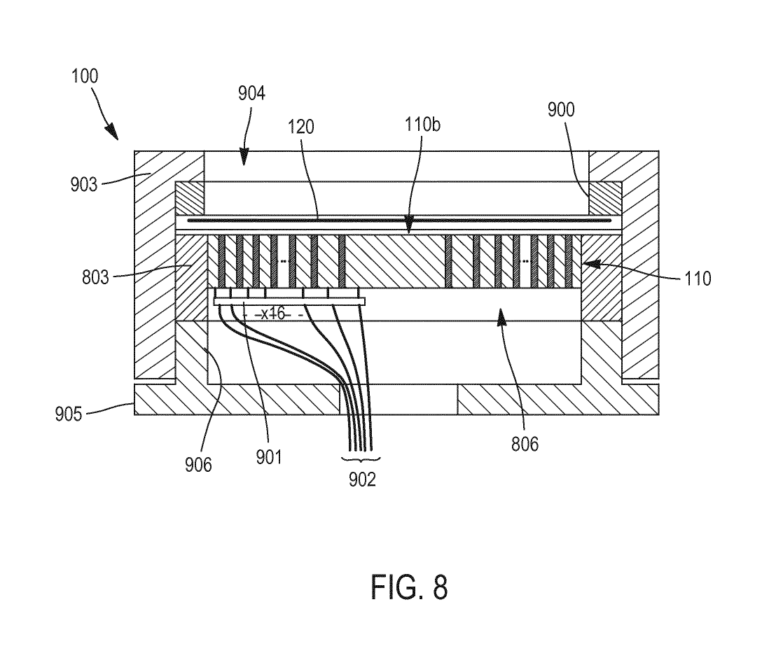

One way to manufacture and assemble the components of the multi-element ultrasonic transducer 100 will now be described in connection with FIGS. 7A-7E and 8.

FIGS. 7A to 7E represent steps S1 to S5 of a method for manufacturing the rear plate 110 comprising the central disc and the concentric rings. This method enables a rear plate provided with a central disc and at least one concentric ring to be manufactured simply and at a lesser cost. It is applicable whatever the number N of elements, the radius R1 of the central disc and the spacing d between the elements (within the limits of the machining manufacture). It turns out to be particularly beneficial for a high number of rings (N>10), as in the case of the transducer according to the invention.

In step S1 of FIG. 7A, annular grooves 800 are machined in a metal disc 801, preferably of aluminium. The grooves 800 are concentric and intended to delimit the elements of the rear plate. In the example represented, the thickness of the metal disc 801 is 10 mm, whereas the grooves 800 have a depth of about 7 mm. Consequently, the grooves 800 do not extend throughout the thickness of the metal disc 801. The grooves have preferably the same width, for example 1.4 mm, such that the elements of the rear plate are regularly spaced.

In step S2 (FIG. 7B), a dielectric material is deposited in the grooves 800 until a layer 802 of dielectric material is additionally formed on the upper face of the metal disc 801. The dielectric material is an adhesive, preferably a bi-component epoxy resin.

Then, in S3 (FIG. 7C), the metal disc 801 covered with the resin layer 802 is inserted in a rear plate holder 803 of electrically insulating material, for example of polyvinyl chloride (PVC). The holder 803 comprises a housing 804 provided to receive the metal disc 801. The metal disc 801 is pushed into the housing 804 until the resin layer 802 contacts the bottom of the housing 804. The resin fulfils several functions, including that of adhering the metal disc 801 in the holder 803.

Preferably, the housing 804 has a height equal to the thickness of the metal disc 801 (10 mm) and the total thickness of the holder 803 is for example 15 mm. The housing 804 has a diameter slightly higher than that of the disc 801, such that the resin overflows at the periphery of the disc, in the space located between the metal disc 801 and the sidewall of the holder 803.

A groove 806 is advantageously provided through the bottom of the housing 804, up to the upper face of the holder 803. When the metal disc 801 is pressed against the bottom of the housing 804, the extra resin flows and is discharged through this port. A piercing hole (not represented in FIG. 7C) can also be provided in the sidewall of the holder 803, in substitution or complementarily to the groove 806, in order to discharge the extra resin.

Step S4 of FIG. 7D consists in machining, preferably using a lathe, the lower portions of the metal disc 801 and of the holder 803 until the resin located in the grooves 800 is reached, for example on a thickness of about 4 mm. The grooves 800 filled with adhesive thus become through grooves, that is they extend from one face to the other of the metal plate. The different portions of the metal disc 801 intended to form the conductive elements of the rear plate of the transducer are thus separated. The resin arranged between the conductive elements ensures holding them as a single piece and electrically insulate them from each other.

Machining of step S4 is advantageously performed such that the rear plate 110 and the holder 803 have a planar “ground” surface. Thus, the risk of deteriorating (through shearing) the membrane 120 arranged subsequently on this surface is reduced.

During step S4, the groove 806 can also be widened by milling, in order to offer access, at the rear face 110a of the rear plate, to all the conductive elements of the rear plate. This access is intended to the electrical connectors of the rear plate.

Preferably, the manufacturing method further comprises a step of preparing S5 the active surface area of the rear plate 110 (adhered in the holder 803), in order to create micro-cavities (in the order of one μm). This step S5 is illustrated by FIG. 7E and comprises at least one micro-sandblasting operation. The micro-cavities are formed at the front face 110b of the rear plate 110 by projecting hard grains the diameter of which is determining to provide a wide frequency bandwidth and an optimum efficiency to the multi-element ultrasonic transducer.

The step S5 of preparing the front face 110b preferentially consists of several sub-steps: at least one polishing operation, one micro-sandblasting operation and one washing operation. Indeed, the side-facing tool used upon machining the rear plate 110 (in step S4) leaves a rough surface state. In particular, the front (active) face 110b of the rear plate 110 has asperities with dimensions much higher than the micro-cavities intended. It is thus necessary to remove these unevenesses before creating the micro-cavities by sandblasting.

First, a surface called a mirror type reference surface is made by polishing, for example by successively applying sandpapers with an increasing particle size distribution (180, 400, 800 and then 1 200 grains/cm²) and then by successively using diamond pastes with a roughness of 3 μm, 1 μm and ¼ μm. Sandblasting is then performed by projecting on the front face 110b of the rear plate 110 a grinding powder (for example white Coridon F400 with a mean particle size distribution equal to 17 μm), preferably under a pressure of 5 bar with a nozzle having a diameter of 1.8 mm. The whole made of the rear plate 110 and the holder 803 is preferably held at about ten centimetres from the nozzle. The sandblasting is performed until a uniform surface (with the naked eye) is obtained in the front face 110b of the rear plate 110. Finally, the rear plate-holder assembly is washed to remove the particles generated by the polishing and the sandblasting operations, and then dried. The washing is for example performed in an ultrasound bath.

FIG. 8 represents a preferential implementation of the step of assembling the rear plate 110 with the membrane 120 and other components of the multi-element ultrasonic transducer 100.

The membrane 120 is deposited onto the front face 110b of the rear plate 110, by orienting outwardly its metallised (aluminium) conducting face. The membrane 120 has been previously cut out about a cylindrical template with a diameter higher than the diameter of the rear plate 110, such that the peripheral edge of the membrane 120 leans on the insulating holder 803. Thus, the membrane 120 covers the entire active surface area of the rear plate 110 and, for example, half the width of the insulating holder 803.

A holding ring 900 (for example of aluminium), with an internal diameter slightly higher than the diameter of the rear plate 110, is deposited onto the front face of the membrane 120, in vertical line with the holder 803 located on the other side of the membrane, that is at the rear face. The holding ring 900 has advantageously a chamfer on its internal diameter and a mirror ground surface state in order not to subsequently damage the membrane upon assembling or operating the transducer 100.

Besides, an electric connector 901 is arranged in the groove 806 of the holder 803, in contact with the rear face of the different conductive elements. The electric connector 901 is connected by a set of electric wires 902 to a control electronics (not represented in FIG. 8) comprising a power supply and/or a processing circuit. The connector 901 will be subsequently used to convey A-C excitation signals to the conductive elements (when the transducer is in the transmitter mode) or to recover measurement signals (when the transducer is configured in the receiving mode).

The electric connector 901 also enables a D-C bias voltage (preferably between 30V and 100V) to be applied to the conductive elements of the rear plate 110, whereas the holding ring 900, which is electrically conductive, ensures the grounding of the membrane 120 (see also FIG. 1). Under the effect of this bias voltage, the membrane 120 is tensioned. The D-C bias voltage is held when assembling the transducer, and then when it is operated. A perfectly tensioned membrane, without any air bubble trapped between the membrane and the rear plate 110, ensures an optimum final efficiency.

Then, assembling these different components (rear plate in its holder, membrane and holding ring) is made inside a cylindrical case 903 (of conducting material, for example of aluminium) until the holding ring 900 abuts against the bottom of the case 903. The bottom of the case 903 has a circular aperture 904, with a diameter equal to the internal diameter of the holding ring 900, which allows the membrane 120 to be viewed.

Finally, a rear cap 905 (of electrically conducting material, for example of aluminium) is attached to the cylindrical case 903, facing the rear plate 110, for example by means of several screws. The rear cap 905 is provided with a projecting portion 906, which abuts against the holder 803 of the rear plate 110. When the cap 905 is screwed to the cylindrical case 903, this projecting portion 906 bears against the holder 803, so as to abut the membrane 120 against the holding ring 900 (which is nestled in the bottom of the case 903).

At the end of this assembling, the multi-element ultrasonic transducer 100 is operational.

Many alternatives and modifications of the manufacturing method according to the invention will appear to those skilled in the art. In particular, this method is not limited in the order of the assembling steps just described in reference to FIG. 8. It is in particular possible to successively introduce the holding ring 900, the membrane 120 and the rear plate 110 in the cylindrical case 903, rather than introducing all these elements simultaneously. On the other hand, other ways to connect the conductive elements of the rear plate to the control electronics can be contemplated.

1. A multi-element capacitive ultrasonic air-coupled transducer comprising:
a membrane having an electrically conductive face; and
a plurality of electrically independent conductive elements, consisting of a central disc and a plurality of rings arranged concentrically with the central disc, the conductive elements each having a face arranged facing the membrane and said faces of the conductive elements being of the same surface area;
wherein the central disc has a radius between 10 mm and 15 mm and wherein the number of the conductive elements is between 12 and 18.

2. The transducer according to claim 1, wherein the conductive elements are separated by a distance between 1 mm and 1.8 mm.

3. The transducer according to claim 1, wherein the conductive elements are 16 in number and wherein the central disc has a radius equal to 10 mm.

4. The transducer according to claim 3, wherein the conductive elements are spaced by a distance equal to 1.4 mm.

5. The transducer according to claim 2, wherein the conductive elements are separated by a distance between 1.4 mm and 1.6 mm.
